(19) United States
(12) Patent Application Publication
(10) Pub. No.: US 2021/0294473 A1
(43) Pub. Date: Sep. 23, 2021

(54) GESTURE DETECTION FOR NAVIGATION THROUGH A USER INTERFACE

(71) Applicant: REMARKABLE AS, Oslo (NO)

(72) Inventor: Stig Hornang, Oslo (NO)

(21) Appl. No.: 17/204,834

(22) Filed: Mar. 17, 2021

Related U.S. Application Data
(60) Provisional application No. 62/991,542, filed on Mar. 18, 2020.

(51) Int. Cl. G06F 3/0488

(52) U.S. Cl. CPC G06F 3/0488

(57) ABSTRACT

One embodiment of a disclosed system, method, and computer readable storage medium which includes instructions for evaluating the intention of a gesture performed on a contact-sensitive display. A tablet scribe system detects a gesture performed using an input mechanism on a contact-sensitive screen of a display system and identifies a path of points on the contact-sensitive screen that the gesture traversed. The system determines rule values for each of a plurality of gesture rules based on the path of points, which describe a measurement of a property of the gesture that informs whether the gesture was performed intentionally. Based on the rule values, the system determines a representative rule value that describes a likelihood that the gesture was performed intentionally and classifies the gesture as intentional or unintentional based on the representative rule value. If intentional, the system enables (or provides) for display) a rendering of the gesture on the contact-sensitive screen.

### CROSS REFERENCE TO RELATED APPLICATIONS

This application claims the benefit of U.S. Provisional Patent Application No. 62/991,542, filed on Mar. 18, 2020, which incorporated herein in its entirety for all purposes.

### TECHNICAL FIELD

The disclosure relates generally to methods and systems for enabling a user to interact with a user interface on a mobile device, and more specifically, to distinguishing between intentional inputs and unintentional inputs from a user.

### BACKGROUND

Devices with displays configured to process tactile inputs, for example, through a stylus or touch from the user, conventionally struggle with distinguishing intentional gestures, for example a writing or selection using a stylus, from unintentional gestures, for example a user's arm resting against the display. Accordingly, such devices often process unintentional gestures as intended by the user, which causes the user interface to navigate away from content that a user actually requested or to display incorrect content to the user. Accordingly, there exists a need for techniques for correctly classifying detected gestures as intentional or unintentional.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a system architecture for a scribe device for transcribing content on a screen based on user input, according to one example embodiment.

FIG. 2 is a block diagram of the system architecture of a tablet scribe device, according to one example embodiment.

FIG. 3 is a block diagram of the system architecture of an input detector module, according to one example embodiment.

FIG. 4 is a flowchart of a process for classifying intentional and unintentional gestures, according to one example embodiment.

FIGS. 5A-C are example illustrations of rules for classifying intentional and unintentional gestures, according to one example embodiment.

FIG. 6 is a block diagram illustrating components of an example machine able to read instructions from a machine-readable medium and execute them in a processor (or controller), according to one example embodiment.

The figures depict various embodiments of the presented invention for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### I. Overview

Disclosed is a configuration (including a system, a process, as well as a non-transitory computer readable storage medium storing program code) for detecting user inputs and classifying the inputs as either intentional or unintentional (e.g., inadvertent). As described herein, user inputs are referred to as “gestures.” In one embodiment, the configuration includes, for example, a gesture input detector, to process properties of a detected gesture in a view of one or more gesture classification rules to classify the gesture as intentional or unintentional.

### II. System Configuration

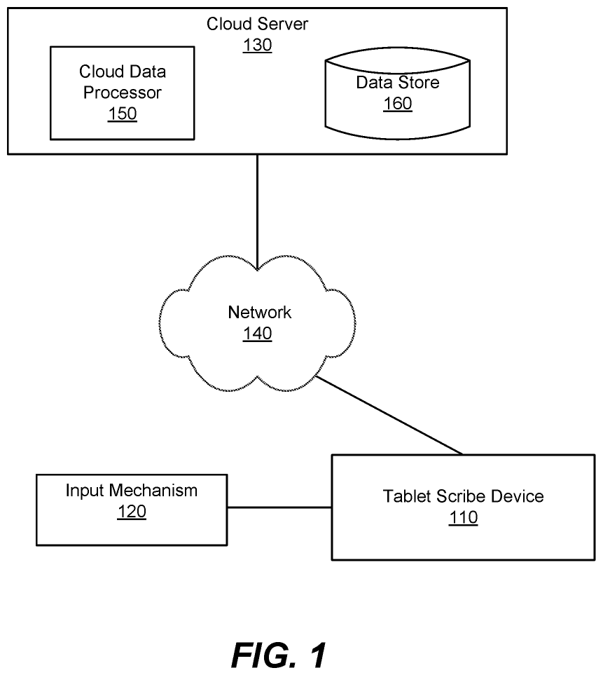

Turning now to FIG. 1, it illustrates a system architecture for a scribe device that enables (or provides) for display on a screen (or display) rendered free form input from a user (e.g., handwriting, gesture or the like), according to one example embodiment. In the example embodiment illustrated in FIG. 1, the system environment may comprise a tablet scribe device 110, an input mechanism 120, a cloud server 130, and a network 140.

The tablet scribe device 110 may be a computing device configured to receive contact input (e.g., detect handwriting, gestures (generally, gestures)) and process the gestures into instructions for updating the user interface to provide, for display, a response corresponding to the gesture (e.g., show the resulting gesture) on the device 110. Examples of the tablet scribe device 110 may include a computing tablet with a touch sensitive screen (hereafter referred to as a contact-sensitive screen). It is noted that the principles described herein may be applied to other devices coupled with a contact-sensitive screen, for example, desktop computers, laptop computers, portable computers, personal digital assistants, smartphones, or any other device including computer functionality.

The tablet scribe device 110 receives gesture inputs from the input mechanism 120, for example, when the input mechanism 120 makes physical contact with a contact-sensitive surface (e.g., the touch-sensitive screen) on the tablet scribe device 110. Based on the contact, the tablet scribe device 110 generates and executes instructions for updating content displayed on the contact-sensitive screen to reflect the gesture inputs. For example, in response to a gesture transcribing a verbal message (e.g., a written text or a drawing), the tablet scribe device 110 updates the contact-sensitive screen to display the transcribed message. As another example, in response to a gesture selecting a navigation option, the tablet scribe device 110 updates the screen to display a new page associated with the navigation option.

The input mechanism 120 refers to any device or object that is compatible with the contact-sensitive screen of the tablet scribe device 110. In one embodiment, the input mechanism 120 may work with an electronic ink (e.g., E-ink) contact-sensitive screen. For example, the input mechanism 120 may refer to any device or object that can interface with a screen and, from which, the screen can detect a touch or contact of said input mechanism 120. Once the touch or contact is detected, electronics associated with the screen generate a signal which the tablet scribe device 110 can process as a gesture that may be provided for display on the screen. Upon detecting a gesture by the input mechanism 120, electronics within the contact-sensitive screen generate a signal that encodes instructions for displaying content or updating content previously displayed on the screen of the tablet scribe device 110 based on the movement of the detected gesture across the screen. For example, when processed by the tablet scribe device 110, the encoded signal may cause a representation of the detected gesture to be displayed on the screen of the tablet scribe device 110, for example a scribble.

In some embodiments, the input mechanism 120 is a stylus or another type of pointing device. Alternatively, the input mechanism 120 may be a part of a user's body, for example a finger and/or thumb.

In one embodiment, the input mechanism 120 is an encased magnetic coil. When in proximity to the screen of the tablet scribe device 110, the magnetic coil helps generate a magnetic field that encodes a signal that communicates instructions, which are processed by the tablet scribe device 110 to provide a representation of the gesture for display on the screen, e.g., as a marking. The input mechanism 120 may be pressure-sensitive such that contact with the contact-sensitive display causes the magnetic coil to compress. In turn, the interaction between the compressed coil and the contact-sensitive screen of the tablet scribe device 110, may generate a different encoded signal for processing, for example, to provide for display a representation of the gesture on the screen that has different characteristics, e.g., thicker line marking. In alternate embodiments, the input mechanism 120 include a power source, e.g., a battery, that can generate a magnetic field with a contact-sensitive surface. It is noted that the encoded signal is a signal that is generated and may be communicated. The encoded signal may have a signal pattern that may be used for further analog or digital analysis (or interpretation).

In one embodiment, the contact-sensitive screen is a capacitive touchscreen. The screen may be designed using a glass material coated with a conductive material. Electrodes, or an alternate current carrying electric component, are arranged vertically along the glass coating of the screen to maintain a constant level of current running throughout the screen. A second set of electrodes are arranged horizontally. The matrix of vertical active electrodes and horizontal inactive electrodes generates an electrostatic field at each point on the screen. When an input mechanism 120 with conductive properties, for example the encased magnetic coil or a human finger, is brought into contact with an area of the screen of the tablet scribe device 110, current flows through the horizontally arranged electrodes, disrupting the electrostatic field at the contacted point on the screen. The disruption in the electrostatic field at each point that a gesture covers may be measured, for example as a change in capacitance, and encoded into an analog or digital signal.

In an alternate embodiment, the contact-sensitive screen is a resistive touchscreen. The resistive touch screen comprises two metallic layers: a first metallic layer in which striped electrodes are positioned on a substrate, for example a glass or plastic and a second metallic layer in which transparent electrodes are positioned. When contact from an input mechanism, for example a finger, stylus, or palm, is made on the surface of the touchscreen, the two layers are pressed together. Upon contact, a voltage gradient is applied to the first layer and measured as a distance by the second layer to determine a horizontal coordinate of the contact on the screen. The voltage gradient is subsequently applied to the second layer to determine a vertical coordinate of the contact on the screen. The combination of the horizontal coordinate and the vertical coordinate register an exact location of the contact on the contact-sensitive screen. Unlike capacitive touchscreens which rely on conductive input mechanisms, a resistive touchscreen senses contact from nearly any input mechanism. Although some embodiments of the scribe device are described herein with reference to a capacitive touchscreen, one skilled in the art would recognize that a resistive touchscreen could also be implemented.

In an alternate embodiment, the contact-sensitive screen is an inductive touchscreen. An inductive touchscreen comprises a metal front layer that detects deflections when contact is made on the screen by an input mechanism. Accordingly, an inductive touchscreen senses contact from nearly any input mechanism. Although some embodiments of the scribe device are described herein with reference to a capacitive touchscreen, one skilled in the art would recognize that alternative touchscreen technology may be implemented, for example, an inductive touchscreen could also be implemented.

The cloud server 130 is receives information from the tablet scribe device and/or communicate instructions to the tablet scribe device 110. As illustrated in FIG. 1, the cloud server 130 may comprise a cloud data processor 150 and a data store 160. Data recorded and stored by the tablet scribe device 110 may be communicated to the cloud server 130 for storage in the data store 160. For example, the data store 160 may store documents, images, or other types of content generated or recorded by a user through the tablet scribe device 110. In some embodiments, the cloud data processor 150 monitors the activity and usage of the tablet scribe device 110 and communicates processing instructions to the tablet scribe device 110. For example, the cloud data processor 150 may regulate synchronization protocols for data stored in the data store 160 with the tablet scribe device 110.

Interactions between the tablet scribe device 110 and the cloud server 130 are typically performed via the network 140, which enables communication between the tablet scribe device 110 and the cloud server 130. In one embodiment, the network 140 uses standard communication technologies and/or protocols including, but not limited to, links using technologies such as Ethernet, 802.11, worldwide interoperability for microwave access (WiMAX), 3G, 4G, LTE, digital subscriber line (DSL), asynchronous transfer mode (ATM), InfiniBand, and PCI Express Advanced Switching. The network 140 may also utilize dedicated, custom, or private communication links. The network 140 may comprise any combination of local area and/or wide area networks, using both wired and wireless communication systems.

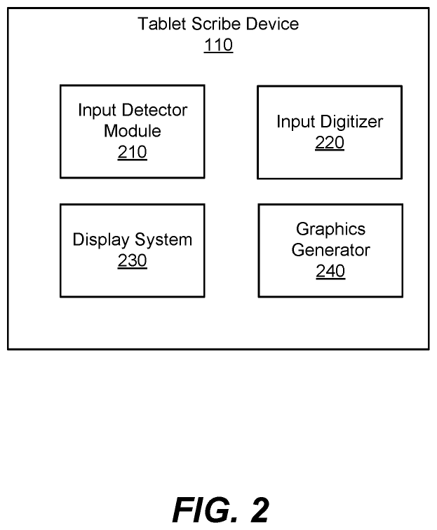

FIG. 2 is a block diagram of the system architecture of a tablet scribe device, according to one example embodiment. In the embodiment illustrated in FIG. 2, the tablet scribe device 110 comprises an input detector module 210, an input digitizer 220, a display system 230, and a graphics generator 240.

The input detector module 210 may recognize that a gesture has been or is being made on the screen of the tablet scribe device 110. The input detector module 210 refers to electronics integrated into the screen of the tablet scribe device 110 that interpret an encoded signal generated by contact between the input mechanism 120 and the screen into a recognizable gesture. To do so, the input detector module 210 may evaluate properties of the encoded signal to determine whether the signal represents a gesture made intentionally by a user or a gesture made unintentionally by a user.

The input digitizer 220 converts the analog signal encoded by the contact between the input mechanism 120 and the screen into a digital set of instructions. The converted digital set of instructions may be processed by the tablet scribe device 110 to generate or update a user interface displayed on the screen to reflect an intentional gesture.

The display system 230 may include the physical and firmware (or software) components to provide for display (e.g., render) on a screen a user interface. The user interface may correspond to any type of visual representation that may be presented to or viewed by a user of the tablet scribe device 110.

Based on the digital signal generated by the input digitizer 230, the graphics generator 240 generates or updates graphics of a user interface to be displayed on the screen of the tablet scribe device. The display system 240 presents those graphics of the user interface for display to a user using electronics integrated into the screen.

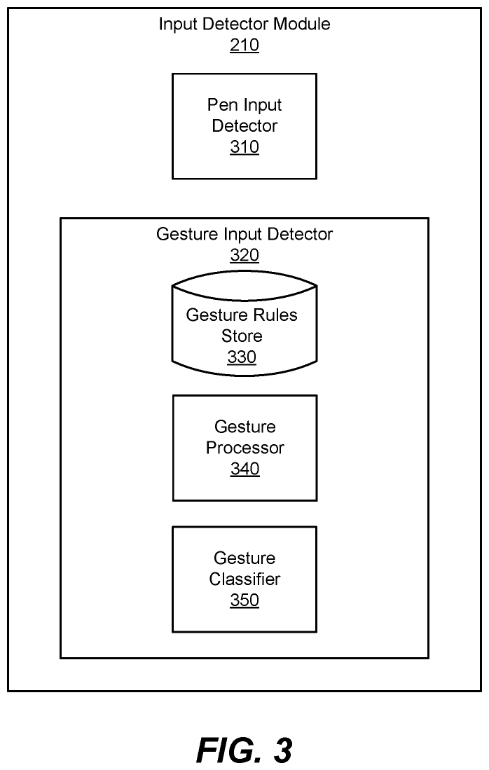

When an input mechanism 120 makes contact with a contact-sensitive screen of a tablet scribe device 110, the input detector module 210 recognizes a gesture has been made through the screen. The gesture may be recognized as a part of an encoded signal generated by the compression of the coil in the input mechanism 120 and/or corresponding electronics of the screen of the display system 230 when the input mechanism makes contact with the contact-sensitive screen. The encoded signal is transmitted to the input detector module 210, which evaluates properties of the encoded signal in view of at least one gesture rule to determine whether the gesture was made intentionally by a user. The input detector module 210 is further described with reference to FIG. 3.

If the input detector module 210 determines that the gesture was made intentionally, the input detector module 210 communicates the encoded signal to the digitizer output 220. The encoded signal is an analog representation of the gesture received by a matrix of sensors embedded in the display of the device 120.

In one example embodiment, the input digitizer 220 translates the physical points on the screen that the input mechanism 120 made contact with into a set of instructions for updating the what is provided for display on the screen. For example, if the input detector module 210 detects an intentional gesture that swipes from a first page to a second page, the input digitizer 220 receives the analog signal generated by the input mechanism 120 as it performs the swiping gesture. The input digitizer 220 generates a digital signal for the swiping gesture that provides instructions for the display system 230 of the tablet scribe device 110 to update the user interface of the screen to transition from, for example, a current (or first page) to a next (or second page, which may be before or after the first page).

In one example embodiment, the graphics generator 240 receives the digital instructional signal (e.g., swipe gesture indicating page transition (e.g., flipping or turning) generated by the input digitizer 220. The graphics generator 240 generates graphics or an update to the previously displayed user interface graphics based on the received signal. The generated or updated graphics of the user interface are provided for display on the screen of the tablet scribe device 110 by the display system 230, e.g., displaying a transition from a current page to a next page to a user.

### III. Detecting Intended and Unintended Gestures

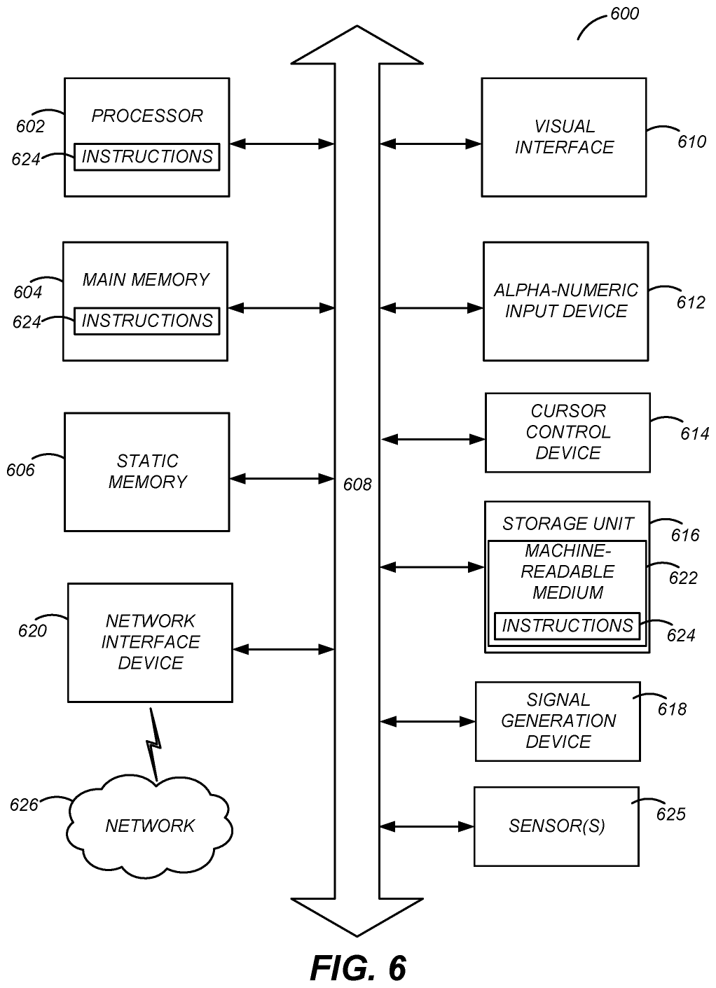

FIG. 3 is a block diagram of the input architecture of an input detector module, according to one example embodiment. The input detector 210 may be part of the tablet scribe device 110, which also may include one or more of the components of a computing device, for example as described with reference to FIG. 6. The input detector module 210 comprises a pen input detector 310 and a gesture input detector 320.

The pen input detector 310 receives the encoded signal generated when an input mechanism 120 makes contact with a contact-sensitive screen, for example a contact between the input mechanism 120 and the screen that compresses a metallic coil in the input mechanism 120. The gesture input detector 320 processes the encoded signal received at the pen input detector 310 to extract certain properties of the gesture encoded in the signal. Based on the extracted properties, the gesture input detector 320 evaluates whether a gesture was intentional or unintentional. The gesture input detector 320 may include a gesture rules store 330, a gesture processor 340, and a gesture classifier 350.

The gesture rules store 330 stores a plurality of gesture rules that distinguish intentional gestures from unintentional gestures. A gesture rule describes a measurable property of a gesture and a condition(s) under which the property indicates that a gesture was performed intentionally. For example, a gesture rule may define a threshold angle between points such that measured angles greater than the threshold angle are associated with unintentionally performed gestures and measured angles less than threshold angle are associated with intentionally performed gestures. Additional examples of gesture rules (which are described in further detail below) include, but are not limited to, a proximity of an input mechanism 120 to a contact-sensitive screen of the table scribe device 110, a set of timeout instructions, one or more geometric conditions of a gesture, and speed linearity measurement for a gesture.

In some embodiments, the encoded signal received by the pen input detector 310 represents a contact between an input mechanism 120 and a single point on the screen of the tablet scribe device 110, for example, the selection of a button displayed on the screen of the tablet scribe device 110. In other embodiments, the contact is a continuous movement or a series of continuous movements across the contact-sensitive screen from the point where the input mechanism first touched the screen (e.g., the start point) to the point where the input mechanism lifted off the screen (e.g., the end point). In alternate embodiments, the gesture input detector 320 may analyze individual segments of a gesture to determine whether the gesture was performed intentionally. It is noted that the encoded signal may be detected as an analog signal and translated into a corresponding digital signal for further processing by the tablet scribe device 110, for example by the input digitizer 420.

The gesture processor 340 of the gesture input detector 320 may identify points on the contact-sensitive screen that a gesture traverses, hereafter referred to as “a path of points.” The path of points begins at a point where the gesture originated (e.g., a “start point”) and ends at a point where the gesture terminated (e.g., an “end point”). The gesture processor 340 may consider the contact-sensitive surface as a coordinate system and identify locations of points on the contact-sensitive screen in the coordinate system. In embodiments where the contact-sensitive screen is a capacitive touchscreen, the gesture processor 340 may identify the points traversed by a gesture (e.g., the path of points) by tracking disruptions in the electrostatic fields generated at each point on the screen.

The encoded signal of a gesture characterizes a combination of properties of the gesture including, but not limited to, measured properties further discussed below, the path of points of the gesture, individual points of the gesture, an amount of time elapsed while the gesture was being made, or a combination thereof. Examples of properties measured by the gesture processor 340 include, but are not limited to, the geometry of the gesture (e.g., a distance covered by the gesture, a start point and an endpoint of the gesture, and an angle of the gesture), and a velocity at which the gesture was made. As described herein, the measured value of a property determined by the gesture processor is referred to as a “rule value.” For example, for a detected gesture, the gesture processor 340 measures an angle between points of a detected gesture and the measurement of the angle is stored as a rule value for the gesture. When compared against a gesture rule of the gesture rules store 330, a rule value may indicate that a gesture was performed intentionally or that the gesture was performed unintentionally.

In embodiments where the gesture processor 340 analyzes individual segments of a gesture, the gesture input detector 320 applies the techniques described below to each segment along a gesture (e.g., a segment between each point of the path of points and a next point) and determines the intentionality of each segment of the gesture. Alternatively, gesture input detector 320 evaluates the intentionality of an entire gesture by applying the techniques discussed below to the start point and the end point of the gesture. In yet another embodiment, the gesture input detector 320 applies the techniques discussed below to each segment of a gesture but determines the intentionality of the entire gesture based on data determined for each segment.

Based on the properties of gesture measured by the gesture processor 340, the gesture classifier 350 evaluates whether the gesture was intentional or unintentional. The gesture classifier 350 of the gesture input detector 320 compares each rule value determined by the gesture processor 340 to a corresponding gesture rule in the gesture rules store 330. As discussed above, a gesture rule may define a threshold measurement for a property that distinguishes gestures performed intentionally from those performed unintentionally. Accordingly, the gesture classifier 350 determines whether a gesture was performed by a user intentionally or unintentionally based on a comparison of a rule value determined by the gesture processor 340 to a gesture rule stored in the gesture rules store 330 and determine whether the gesture rule was satisfied based on the comparison.

In some embodiments, the gesture classifier 350 performs a binary classification indicating whether the threshold prescribed by the corresponding gesture rule was satisfied. For example, if a measured angle between two points of a gesture is less than a threshold angle, the gesture classifier 350 may assign a label indicating that the gesture rule was satisfied, but if the measured angle is greater than the threshold angle, the gesture classifier 350 may assign a label indicating that the gesture rule was not satisfied. In other embodiments, a gesture rule may specify multiple thresholds that create ranges of rule values where each range describes a varying level of confidence that the gesture was performed intentionally, for example “intentional,” “possibly intentional,” or “unintentional” and/or corresponding numerical or alphanumerical value. The label assigned to the gesture is communicated to the display system 230, which displays the gesture if the label indicates the gesture was performed intentionally.

In some embodiments, the gesture processor 340 determines rule values for several properties of the gesture. In such embodiments, the gesture processor 340 determines a representative rule value for the gesture based on an aggregation or combination of the rule values determined by the gesture processor 340. For example, the gesture processor 340 may determine rule values including measurements of angles between points of a gesture, the linearity of the gesture, and the speed linearity of the gesture and determine rule values for each of the gesture rules. The gesture processor 340 may sum, average, or apply any other suitable techniques to the individual rule values to determine a representative rule value for the gesture. Accordingly, the representative rule value describes a comprehensive likelihood that the gesture was performed intentionally. The gesture processor 340 compares the representative rule value for a gesture to a threshold representative rule value stored in the gesture rules store 330 to determine whether a gesture was performed by a user intentionally or unintentionally.

As discussed above, the gesture rules store 330 stores a plurality of rules (or conditions) which distinguish intentional gestures from unintentional gestures. The gesture rules store 330 may store a gesture rule that considers the proximity of an input mechanism 120 to a contact-sensitive screen of a tablet scribe device 110. In embodiments where the input mechanism 120 includes a metallic coil, sensors in the contact-sensitive screen detect the position of the input mechanism 120 above the display of the device 110 based on electrical signals disrupted by the position of the metallic coil. When sensors in the contact-sensitive screen detect that an input mechanism is within a threshold distance of the screen, for example 1 centimeter above the screen, the display system 230 may activate the contact-sensing capabilities of the screen to detect input gestures from the input mechanism 120. When the input gesture moves farther than the threshold distance, for example, because it was dropped or placed on a table, the display system 230 may deactivate the contact-sensing capabilities of the screen. In implementations in which the input mechanism is an item without electrical properties or a body part of a user, sensors in the contact-sensitive screen may determine the distance of the input mechanism 120 relative to the screen by measuring other properties, for example thermal measurements.

Additionally, the gesture rule store 330 may store timeout instructions for deactivating the contact-sensing capabilities of the screen. In one embodiment, a threshold time period, for example between 100 and 300 milliseconds, after detecting a first contact from an input mechanism 120, the display system 230 may deactivate the contact-sensing capabilities of the screen. Alternatively, if the input mechanism 120 continues the first gesture or makes a second gesture within the threshold period of time, the input detector module 210 and/or the display system 230, recognizes and processes the second gesture input. For example, if a user performs a gesture with an input mechanism and then, after the threshold period of time, accidently rests their hand on the screen, the input detector module 210 will only recognize the gesture performed through the input mechanism 120 and not the unintentional gesture of the hand placement.

If the input mechanism 120 continues the first gesture or starts a second gesture after the threshold period of time, the sensors of the contact-sensitive screen coupled to the display system 230 will detect the input mechanism 120 within the threshold distance of the screen and communicate instructions to the display system 230 to reactive the contact-sensing capabilities of the screen. In embodiments where the gesture includes multiple points, the gesture processor 340 determines a time difference between the contact of the input mechanism at the start point and the contact of the input mechanism at the next point on the path of points for the gesture. If the time difference between the contacts is less than a threshold amount of time, the gesture processor 340 identifies the remaining points of the path of points traversed by the gesture between the start point and the end point. Alternatively, if the time difference between contacts is greater than the threshold amount of time, the pen input detector 310 determines a distance between the input mechanism and the contact-sensitive screen and considers whether to deactivate, reactivate, or activate the contact-sensing capabilities of the contact-sensitive screen.

The gesture rules store 330 may additionally store rules that consider the geometry of a gesture, for example the linearity of a gesture, the angle of a gesture, or the distance between points of a gesture. After a gesture has been performed by an input mechanism 120, the gesture processor 340 identifies the start point and the endpoint of the gesture, as well as the remaining path of points of the gesture. If the gesture processor 340 considers a coordinate system of the contact sensitive screen, the gesture processor 340 assigns a coordinate on the contact-sensitive screen to each point of the gesture. Based on the coordinates of the identified points, the gesture processor 340 measures the straightness of a gesture and the gesture rules store 330 stores one or more linearity thresholds for an intended gesture. For example, wavy gestures are likely performed unintentionally because they lack a threshold level of linearity, whereas straight gestures are likely performed intentionally because they satisfy the threshold level of linearity. Based on a comparison of the measured straightness of the gesture to a threshold level of linearity, the gesture classifier 350 determines whether the gesture is intentional or unintentional.

The gesture processor 340 may identify segments between each point of the path of points and the next point on the path of points. By comparing the orientation and position of first segment relative to other adjacent segments of the gesture, the gesture processor 340 may determine the straightness of each segment and aggregate the straightness measurements of each segments into a straightness measurement of the gesture.

In other embodiments, the gesture processor 340 may determine the straightness of a gesture by identifying a linear line that would connect the start point to the end point. The gesture processor 340 may determine a deviation of each remaining point of the gesture's path of points from the linear line (e.g., a distance between the remaining point and the linear line) and compare that distance to a threshold. The deviation of a single point of the gesture beyond the threshold distance may result in the gesture classifier 350 classifying the gesture as unintentional. Alternatively, the gesture classifier 350 may consider the deviation of all points collectively to determine the straightness of the entire gesture or a portion of the gesture.

If the measured straightness of the entire gesture is greater than a threshold level of linearity, the gesture classifier 350 determines that the gesture is intentional. If the measured straightness of the gesture is less than a threshold level of linearity, the gesture classifier 350 determines that the gesture is unintentional. If the gesture is determined to be intentional, the encoded signal received from the input mechanism 120 is communicated to the input digitizer 220 as described above. If the gesture is determined to be unintentional, the encoded signal is ignored by the input detector module 210. Alternatively, the gesture classifier may consider subsets of points along the gesture to analyze the straightness of portions of the gesture using the techniques discussed above.

Based on the identified coordinates of the path of points, the gesture processor 340 may determine an angle between points of the gesture. In one embodiment, the gesture processor 340 determines an angle between each point on the gesture's path of points and the next point on the gesture. If an angle between two points does not satisfy the corresponding gesture rule, the gesture classifier 350 may determine a rule value for the segment of the gesture that indicates the segment was unintentional. In some embodiments, the gesture classifier 350 may determine a rule value that indicates the entire gesture was performed unintentionally if an angle between any two points of the gesture does not satisfy the corresponding gesture rule. In another embodiment, if the gesture classifier 350 determines an aggregate angle by aggregating or averaging each angle between points on the gesture and classifies the gesture as intentional or unintentional based on the aggregate angle. Alternatively, the gesture classifier 350 may determine the aggregate angle for the gesture by comparing the coordinate of the end position of the gesture to the coordinate of the start position.

By comparing the angle between two points on the gesture and the threshold angle defined by a gesture rule, the gesture classifier 350 determines whether the gesture is intentional or unintentional. If the determined angle is less than a threshold angle (e.g., two points along the gesture are nearly in the same direction), the gesture between those two points is determined to be intentional. If the determined angle is greater than the threshold angle (e.g., two points along the gesture are not in the same direction), the gesture between those two points is determined to be unintentional. In embodiments where the gesture classifier 350 considers angles between two points individually, the gesture classifier 350 may determine that certain segments of a gesture where performed intentionally, while other segments were performed unintentionally. For example, a user may intentionally perform a gesture by writing on the contact-sensitive screen with an input mechanism 120, before the input mechanism 120 slips across the contact-sensitive screen and results in an unintentional segment of the gesture.

The gesture rules store 330 may additionally store a gesture rule describing a threshold for speed linearity measurements of a gesture. As described herein, speed linearity describes the acceleration of a gesture. A speed linearity measurement of zero indicates that a gesture had a constant seed, for example a straight line on a plot of gesture position versus time. A negative speed linearity measurement indicates that a gesture had a negative acceleration while being drawn, whereas a positive speed linearity measurement indicates that a gestured had a positive acceleration while being drawn. Accordingly, in one embodiment, the gesture processor 340 determines the speed linearity of each segment of a gesture. To do so, the gesture processor 340 determines a distance between each point on the gesture and the next point and a velocity at which the input mechanism move from the point on the gesture to the next point. The gesture processor 340 determines the acceleration of the gesture based on the distance between the point and the next point and the velocity at which the input mechanism moved.

In another embodiment, the gesture processor 340 determines the speed linearity of the entire gesture based on the start point and end point of the gesture. To do so, the gesture processor 340 determines a distance between the start point and the end point and a velocity at which the input mechanism moved along the path of points to to perform the gesture. The gesture processor 340 determines the acceleration of the gesture based on the distance between the start point and the end point and the velocity at which the gesture was performed.

In either embodiment, if the determined speed linearity exceeds the threshold stored in the gesture rules store 330, the gesture classifier 350 identifies the gesture as unintentional. Returning to example above involving a user writing using the input mechanism 120, the input mechanism 120 slipping will likely result be an acceleration from the user's intentional writing. Alternatively, if the determined speed linearity is below the threshold, the gesture classifier 350 identifies the gestures as intentional.

Alternatively, or in addition to the embodiments discussed above, the gesture rules store 330 may store a gesture rule that prescribes a threshold range of speed linearity measurements. If the gesture processor 340 determines a speed linearity measurement to be within the threshold range, the gesture classifier 350 identifies the gesture as intentional. If the gesture processor 340 determines the speed linearity measurement to be outside the threshold range, the gesture classifier 350 identifies the gesture as unintentional.

In some embodiments, the gesture processor 340 may determine that between segments of a gesture, speed linearity is highly varied, for example a second segment of the gesture is performed slower than the first segment of the gesture and a third segment is performed faster than the second segment. In such instances, the gesture classifier 350 may identify the gesture as unintentional based on its inconsistent varied speed. In comparison, the gesture classifier 350 may classify a performed at a consistent speed as intentional. In other embodiments, the gesture classifier 340 identifies gestures that are initially performed at slowly before picking up speed as intentional gestures. In comparison, the gesture classifier 350 may identify gestures that are initially performed at a rapid speed before slowing down as unintentional gestures.

The gesture rules store 330 may additionally store a gesture rule describing a threshold distance between points along a gesture. The gesture processor 340 may determine the distance between each point along the path of points and a next point based on the coordinates of each point. Based on a comparison of each point to the threshold described in the gesture rule, the gesture classifier 350 may classify the gesture as intentional or unintentional. Additionally, the gesture processor 340 may measure the size of a point generated when an input mechanism makes contact with the contact-sensitive screen or each point on the gesture of points. The gesture processor 340 compares the size of the point to a threshold point size described in a gesture rule of the gesture rules store 330 and may identify points greater than the threshold size as unintentional, for example points caused by a user resting their hand on the contact-sensitive screen, and may identify any points less than the threshold size as intentional.

The gesture processor 340 may additionally determine if contact was made at a point on the contact-sensitive screen that is beyond the path of points of a gesture. If second point of contact is detected within a threshold distance (e.g., a minimum distance) of a point along the gesture, the gesture classifier 350 identifies the gesture was unintentional. If the other point is detected outside of the threshold distance, the gesture classifier 350 identifies the gesture as intentional. In some embodiments, the gesture classifier 350 determines the gesture to be unintentional based on solely on the detection of the second point.

Using the techniques discussed above, the gesture processor 340 and gesture classifier 350 may evaluate the intentionality of a gesture based on individual gesture classification rules. In addition to the techniques discussed above, the gesture classifier 350 may evaluate whether a gesture was performed intentionally or unintentionally based on representative rule value determined for the gesture based on a combination of rules values determined for multiple gesture rules. As discussed above, the gesture processor 340 determines a rule value for each gesture rule, for example a measurement of the proximity of an input mechanism, a straightness measurement of the gesture, an angle measurement of the gesture, a speed linearity measurement of the gesture, a distance between points along the gesture, and a size measurement for points along the gesture. The gesture processor 340 inputs each determined rule value into a function that outputs a representative rule value for the gesture. For example, the algorithm may classify a gesture with a speed linearity rule value above 0.5 and a straightness rule value above 0.015 is classified by the algorithm as an unintentional gesture.

The gesture rules store 330 stores a threshold representative rule value to be used in implementations in which a representative rule value is determined. Accordingly, the gesture classifier 350 compares the representative rule value output by the function to the threshold representative rule value. If the representative rule value is greater than the threshold, the gesture classifier 350 confirms that the gesture was intentional and communicates the analog signal to the input digitizer 220. If the representative rule value is less than the threshold representative rule value, the gesture classifier 350 identifies the gesture as unintentional and confirms instructions for the detected gesture to be ignored.

In some embodiments, the input detector module 210 may detect start points for multiple simultaneous gestures on the screen, for example when a user performs a five-finger swiping gesture. In such embodiments, the gesture processor 340 determines a representative start point and end point for all the simultaneously detected gestures, for example by computing a centroid or an average coordinate position based on the start point and end point of each simultaneous gesture. Based on the representative start point and end point of the simultaneous gestures, the gesture processor 340 determines rule values for one of more gesture rules and the gesture classifier 350 classifies the combination of gestures as intentional or unintentional using the techniques described above.

Additionally, the gesture input detector 320 accounts for implementations where one or more gestures are made intentionally and one or more gestures are simultaneously made unintentionally, for example a user using a stylus to make a gesture while their arm also brushes across the screen. In such implementations, the gesture input detector 320 may process each permutation or combination of the simultaneously performed gestures. For example, when a user intentionally performs a two-finger swipe on the screen of the tablet scribe device 110 there are three possible permutations: 1) only the gesture of finger 1 is intentional 2) only the gesture of finger 2 is intentional and 3) the gestures of both fingers 1 and 2 are intentional. The gesture processor 340 determines a representative rule value (or rule value) for each possible permutation and compares each representative rule value to the threshold representative rule value. If the representative rule value for only one permutation is above the threshold, the gesture classifier 350 identifies the gestures considered in the permutation as intentionally performed. If multiple representative values are above the threshold, the gesture classifier 350 identifies gestures considered in the permutation corresponding to the highest representative rule value as intentional gestures. If no representative rule values are above the threshold, the gesture classifier 350 classifies none of the detected gestures as intentional.

Additionally, the pen input detector 310 may record an amount of time that an input mechanism was in contact with a single point on the display, for example a hand resting on the contact-sensitive screen. If the amount of time exceeds a threshold amount of time, the pen input detector 310 identifies the gesture as unintentional. The gesture processor 340 may additionally consider an amount of time elapsed between the contact of the input mechanism at the start point on the screen and the contact of the input mechanism at the end point on the screen. If the amount of time elapsed is greater than a threshold amount of time, the gesture classifier 350 may identify the gesture as unintentional. Alternatively, if the amount of time is less than the threshold amount of time, the gesture classifier 350 may identify the gesture as intentional.

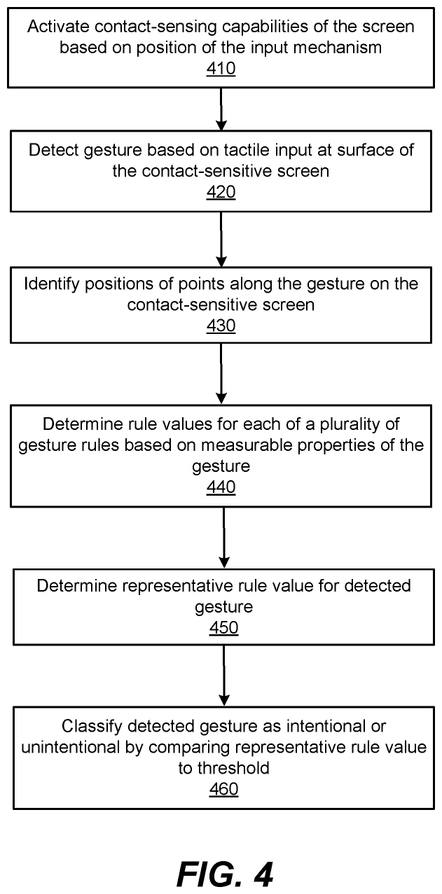

FIG. 4 is a flowchart of a process for classifying intentional and unintentional gestures, according to one example embodiment. As described above, the input detector module 210 determines a distance between the input mechanism 120 and the contact-sensitive screen. If the determined distance is less than a threshold distance, the display system 230 activates 410 the contact-sensing capabilities of the screen to detect potential gestures. The input detector module 210 detects 420 a potential gesture based on tactile input on the surface of the contact-sensitive screen.

The input detector module 210 identifies 430 positions of points along the gesture on the contact-sensitive screen including a start point of the gesture, an endpoint of the gesture, and any intermediate points that the gesture traverses. Between each point position and/or for the gesture as a whole, the input detector 210 determines 440 rule values for one or more gesture rules. Based on those rule values, the input detector 210 determines 450 a representative rule value for the detected gesture. The representative rule value describes a confidence level that a detected gesture is an intentional gesture based on a combination of the gesture rules. Based on a comparison of the representative rule value to a threshold representative rule value, the input detector module 210 classifies 460 the detected gestures as intentional or unintentional. If the representative rule value is greater than the threshold, the input detector module 210 classifies the detected gesture as intentional. If the representative rule value is less than the threshold, the input detector module 210 classifies the detected gesture as unintentional.

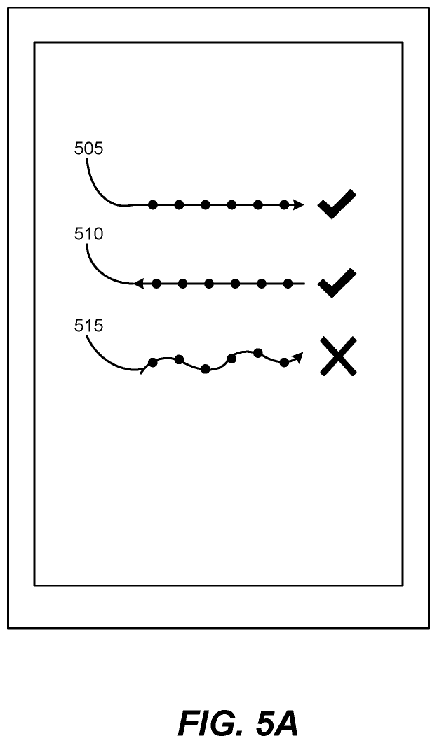

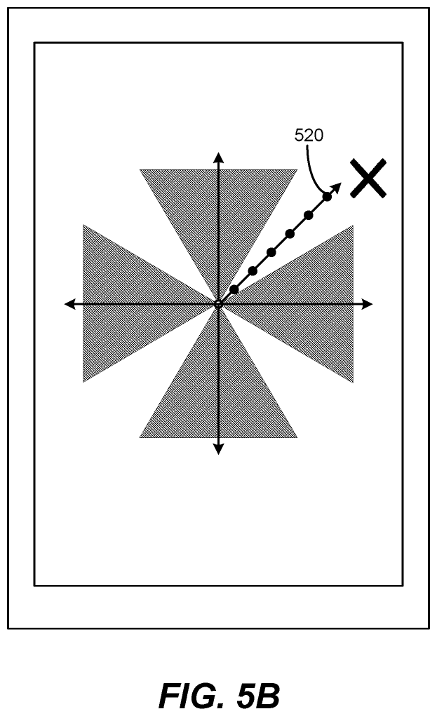

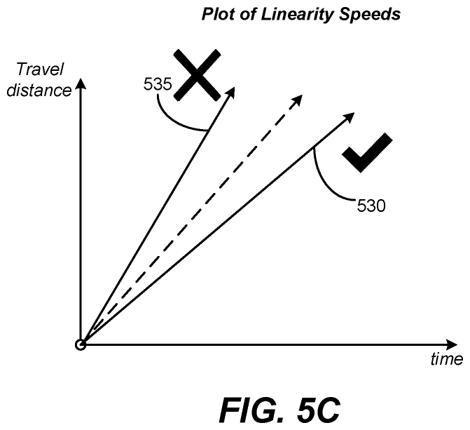

FIGS. 5A-C are example illustrations of rules for classifying intentional and unintentional gestures, according to one example embodiment. FIG. 5A is an example illustration of an application of a gesture rule for straightness, according to an example embodiment. Points along the gesture 505 follow a consistent linear pathway moving from left to right. Accordingly, the gesture 505 represents a movement across the screen of the tablet scribe device 110 with a high straightness rule value. Based on the gesture rule for straightness described above, the gesture input detector 320 may classify the gesture 505 as intentional (indicated though a check mark). Similarly, points along the gesture 510 follow a consistent linear pathway moving from right to left. Accordingly, the gesture 510 represents a movement across the screen with a high straightness rule value. Based on the gesture rule for straightness described above, the gesture input detector 320 may also classify the gesture 510 as intentional.

In comparison, points along the gesture 515 do not follow a consistent linear pathway in either direction. Accordingly, the gesture 515 represents a movement with a low straightness rule value. Accordingly, based on the gesture rule for straightness described above, the gesture input detector 3420 may classify the gesture 515 as unintentional (indicated through a cross mark (“x”)). In some embodiments, the gesture 515 may additionally be compared to a set of known gestures known to supply inputs to a contact-sensitive display. If the gesture 515 matches a gesture of the known set, the gesture 515 may be determined to be intentional, despites the low straightness rule value.

FIG. 5B is an example illustration of an application of a gesture rule for gesture angles, according to an example embodiment. For the sake of simplicity, in the illustrated embodiment of FIG. 5B, only gestures moving in four cardinal directions (both horizontal directions and both vertical directions) are classified as intentional. Each of the four directions is additionally associated with an angle tolerance radius, such that gestures made within the tolerance radius of one of the four directions may still be classified as intentional. As illustrated, the gesture 520 travels through a set of points that lie outside the tolerance radius of all four directions. Accordingly, based on the gesture rule for gesture angles described above, the gesture input detector 320 may classify the gesture 520 as unintentional. Embodiments of the gesture angle rule may further recognize several additional directions between each of the four cardinal directions as representative of intentional gestures and each of the additional directions may be associated with their own tolerance radius.

FIG. 5C is an example illustration of an application of a gesture rule for speed linearity, according to an example embodiment. As described above, a speed linearity rule value is determined based on the distance between a start point and an end point of a gesture (e.g., the distance traveled on the display when performing the gesture) and the time taken to perform the gesture. Accordingly, speed linearities for gestures may be illustrated on a graph of travel distance vs. time, for example as illustrated in FIG. 5C. In the FIG. 5C, the dashed line represents a threshold speed linearity rule value (e.g., a threshold slope of speed linearity). Gestures below the threshold, for example gesture 530, may be classified as intentional and gestures above the threshold, for example gesture 535, may be classified as unintentional.

### IV. Computing Machine Architecture

FIG. 6 is a block diagram illustrating components of an example machine able to read instructions from a machine-readable medium and execute them in a processor (or controller), according to one embodiment. Specifically, FIG. 6 shows a diagrammatic representation of a machine in the example form of a computer system 600 within which program code (e.g., software) for causing the machine to perform any one or more of the methodologies discussed herein may be executed. The tablet scribe device 110 may include some or all of the components of the computer system 600. The program code may be comprised of instructions 624 executable by one or more processors 602. In the tablet scribe device 110, the instructions may correspond to the functional components described in FIGS. 2 and 3 and the processing steps described with FIGS. 4-5C.

While the embodiments described herein are in the context of the tablet scribe device 110, it is noted that the principles may apply to other touch sensitive devices. In those contexts, the machine of FIG. 6 may be a server computer, a client computer, a personal computer (PC), a tablet PC, a personal digital assistant (PDA), a cellular telephone, a smartphone, a web appliance, an internet of things (IoT) device, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processors 602 (e.g., a central processing unit (CPU), one or more graphics processing units (GPU), one or more digital signal processors (DSP), one or more application specific integrated circuits (ASICs), one or more radio-frequency integrated circuits (RFICs), or any combination of these), a main memory 604, and a static memory 606, which are configured to communicate with each other via a bus 608. The computer system 600 may further include visual display interface 610. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 610 may include or may interface with a touch enabled screen, e.g. of the tablet scribe device 110 and may be associated with the display system 230. The computer system 600 may also include alphanumeric input device 612 (e.g., a keyboard or touch screen keyboard), a cursor control device 1014 (e.g., a mouse, a trackball, a joystick, a motion sensor, or other pointing instrument), a storage unit 616, a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 (e.g., software) may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., instructions 624) for execution by the machine and that cause the machine to perform any one or more of the methodologies disclosed herein. The term “machine-readable medium” includes, but not be limited to, data repositories in the form of solid-state memories, optical media, and magnetic media.

The computer system 600 also may include the one or more sensors 625. Also note that a computing device may include only a subset of the components illustrated and described with FIG. 6. For example, an IoT device may only include a processor 602, a small storage unit 616, a main memory 604, a visual interface 610, a network interface device 620, and a sensor 625.

### V. Additional Considerations

The disclosed gesture detection system enables a table scribe device 110 to determine whether a gesture was performed by a user intentionally or unintentionally. Compared to conventional touch-sensitive systems which display and react to gestures on contact-sensitive surfaces regardless of whether a user intended to make the gestures, the described tablet scribe device 110 evaluates whether a gesture was performed intentionally or unintentionally based on measurable properties of the gesture. If the gesture is determined to have been performed intentionally, the table scribe device 110 processes and updates the display according to the gesture. As a result, unlike conventional systems, the table scribe device 110 does not burden a user with having to react or adjust to changes in displayed content that result from accidental or unintentional contact with a contact-sensitive screen.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for systems and a process for determining whether a gesture on a contact-sensitive surface was performed intentionally or unintentionally through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer-readable medium comprising stored computer-readable instructions for evaluating an intention of a gesture performed on a contact-sensitive screen that, when executed by a processor, cause the processor to:
detect, at the contact-sensitive screen, a gesture performed using an input mechanism, the gesture having been encoded in a signal generated by contact between the input mechanism and the contact-sensitive screen;
identify, from the encoded signal of the gesture, a path of points on the contact-sensitive screen that the gesture traversed, wherein the path of points begins at a start point on the contact-sensitive screen and ends at an end point on the contact-sensitive screen;
determine rule values for each of a plurality of gesture rules based on the path of points, wherein each rule value represents a measurement of a property of the gesture that informs whether the gesture was performed intentionally;
determine a representative rule value based on a combination of the rule values determined for the plurality of gesture rules, the representative rule value describing a likelihood that the gesture was performed intentionally based on a combination of conditions for a gesture to be performed intentionally; and
classify, upon a determination that the representative rule value is greater than a threshold representative rule value, the gesture as intentionally performed by the input mechanism; and
enable for display the gesture on the contact-sensitive screen over the path of points on the contact-sensitive screen.

2. The non-transitory computer-readable medium of claim 1, comprising further instructions that when executed cause the processor to:
determine a time difference between contact between the input mechanism and the contact-sensitive screen at the start point and contact between the input mechanism and the contact-sensitive screen at a next point on the path of points; and
identify, upon a determination that the time difference is less than a threshold amount of time, remaining points of the path of points traversed by the gesture and the end point.

3. The non-transitory computer-readable medium of claim 2, comprising further instructions that when executed cause the processor to:
deactivate, upon a determination that the time difference is greater than a threshold amount of time, contact-sensing sensors of the contact-sensitive screen;
determine a distance between the input mechanism and the contact-sensitive screen; and
reactivate, upon a determination that the determined distance is within a threshold distance, the contact-sensing sensors of the contact-sensitive screen to identify the next point on the path of points.

4. The non-transitory computer-readable medium of claim 1, wherein a gesture rule of the plurality of gesture rules describes a threshold linearity of the gesture, the non-transitory computer-readable medium comprising further instructions that when executed cause the processor to:
measure, for each point on the path of points, a straightness of each segment of a gesture, wherein each segment of the gesture is formed between each point and a next point on the path of points;
aggregate the measured straightness for each segment of the gesture to determine a straightness measurement for the gesture; and
determine, upon the straightness measurement for the gesture being greater than the threshold linearity, a rule value for the gesture rule indicating that the gesture was performed intentionally.

5. The non-transitory computer-readable medium of claim 1, wherein a gesture rule of the plurality of gesture rules describes a threshold angle between points on the path of points, the non-transitory computer-readable medium comprising further instructions that when executed cause the processor to:
measure, for each point on the path of points, an angle between the point and a next point on the path of points;
determine, upon the measured angle being less than the threshold angle, a rule value for the gesture rule indicating that the gesture was performed intentionally.

6. The non-transitory computer-readable medium of claim 1, wherein a gesture rule of the plurality of gesture rules describes a threshold acceleration of intentionally performed gesture, the non-transitory computer-readable medium comprising further instructions that when executed cause the processor to:
determine a distance between a position of the start point on the contact-sensitive screen and a position of the end point on the contact-sensitive screen;
determine an acceleration of the gesture based on the determined distance and a velocity at which the gesture was performed; and
determine, upon a determination that the acceleration of the gesture is less than the threshold acceleration, a rule value for the gesture rule indicating that the gesture was performed intentionally.

7. The non-transitory computer-readable medium of claim 1, wherein a gesture rule of the plurality of gestures rules describes a threshold size of points along the gesture, the non-transitory computer-readable medium comprising further instructions that when executed cause the processor to:
measure a size of each point on the path of points based on a count of contact-sensitive sensors activated by contact between the input mechanism and the contact-sensitive screen at the point; and
determine, upon the measured size being less than the threshold size, a rule value for the gesture rule indicating that the gesture was performed intentionally.

8. A table device comprising:
an input mechanism;
a contact-sensitive surface; and
a non-transitory computer-readable medium comprising stored computer-readable instructions for evaluating an intention of a gesture performed on a contact-sensitive screen that, when executed by a processor, cause the processor to:
detect, at the contact-sensitive screen, a gesture performed using an input mechanism, the gesture having been encoded in a signal generated by contact between the input mechanism and the contact-sensitive screen;
identify, from the encoded signal of the gesture, a path of points on the contact-sensitive screen that the gesture traversed, wherein the path of points begins at a start point on the contact-sensitive screen and ends at an end point on the contact-sensitive screen;
determine rule values for each of a plurality of gesture rules based on the path of points, wherein each rule value represents a measurement of a property of the gesture that informs whether the gesture was performed intentionally;
determine a representative rule value based on a combination of the rule values determined for the plurality of gesture rules, the representative rule value describing a likelihood that the gesture was performed intentionally based on a combination of conditions for a gesture to be performed intentionally; and
classify, based on the representative rule value being greater than a threshold representative rule value, the gesture as intentionally performed by the input mechanism; and
enable for display the gesture on the contact-sensitive screen over the path of points on the contact-sensitive screen.

9. The tablet device of claim 8, wherein the non-transitory computer-readable medium comprises further instructions that when executed cause the processor to:
determine a time difference between contact between the input mechanism and the contact-sensitive screen at the start point and contact between the input mechanism and the contact-sensitive screen at a next point on the path of points; and
identify, upon determination that the time difference is less than a threshold amount of time, remaining points of the path of points traversed by the gesture and the end point.

10. The tablet device of claim 9, wherein the non-transitory computer-readable medium comprises further instructions that when executed cause the processor to:
deactivate, upon a determination that the time difference is greater than a threshold amount of time, contact-sensing sensors of the contact-sensitive screen;
determine a distance between the input mechanism and the contact-sensitive screen; and
reactivate, upon a determination that the determined distance is within a threshold distance, the contact-sensing sensors of the contact-sensitive screen to identify the next point on the path of points.

11. The tablet device of claim 9, wherein a gesture rule of the plurality of gesture rules describes a threshold linearity of the gesture, the non-transitory computer-readable medium comprising further instructions that when executed cause the processor to:
measure, for each point on the path of points, a straightness of each segment of a gesture, wherein each segment of the gesture is formed between each point and a next point on the path of points;
aggregate the measured straightness for each segment of the gesture to determine a straightness measurement for the gesture; and
determine, upon the straightness measurement for the gesture being greater than the threshold linearity, a rule value for the gesture rule indicating that the gesture was performed intentionally.

12. The tablet device of claim 9, wherein a gesture rule of the plurality of gesture rules describes a threshold angle between points on the path of points, the non-transitory computer-readable medium comprising further instructions that when executed cause the processor to:
measure, for each point on the path of points, an angle between the point and a next point on the path of points;
determine, upon the measured angle being less than the threshold angle, a rule value for the gesture rule indicating that the gesture was performed intentionally.

13. The tablet device of claim 9, wherein a gesture rule of the plurality of gesture rules describes a threshold acceleration of intentionally performed gesture, the non-transitory computer-readable medium comprising further instructions that when executed cause the processor to:
determine a distance between a position of the start point on the contact-sensitive screen and a position of the end point on the contact-sensitive screen;
determine an acceleration of the gesture based on the determined distance and a velocity at which the gesture was performed; and
determine, upon a determination that the acceleration of the gesture is less than the threshold acceleration, a rule value for the gesture rule indicating that the gesture was performed intentionally.

14. The tablet device of claim 9, wherein a gesture rule of the plurality of gestures rules describes a threshold size of points on the path of point, the non-transitory computer-readable medium comprising further instructions that when executed cause the processor to:
measure a size of each point on the path of points based on a count of contact-sensitive sensors activated by contact between the input mechanism and the contact-sensitive screen at the point; and
determine, upon the measured size being less than the threshold size, a rule value for the gesture rule indicating that the gesture was performed intentionally.

15. A system comprising:
a pen input detector configured to detect, at the contact-sensitive screen, a gesture performed using an input mechanism, is the gesture having been encoded in a signal generated by contact between the input mechanism and the contact-sensitive screen;
a gesture processor configured to:
identify, from the encoded signal of the gesture, a path of points on the contact-sensitive screen that the gesture traversed, wherein the path of points begins at a start point on the contact-sensitive screen and ends at an end point on the contact-sensitive screen;
determine rule values for each of a plurality of gesture rules based on the path of points, wherein each rule value represents a measurement of a property of the gesture that informs whether the gesture was performed intentionally;
determine a representative rule value based on a combination of the rule values determined for the plurality of gesture rules, the representative rule value describing a likelihood that the gesture was performed intentionally based on a combination of conditions for a gesture to be performed intentionally; and
a gesture classifier configured to classify the gesture as intentionally performed using the input is upon a determination that the representative rule value being greater than a threshold representative rule value; and
a display system configured to render the gesture on the contact-sensitive screen along the path of points on the contact-sensitive screen.

16. The system of claim 15, wherein:
the gesture input detector is further configured to determine a time difference between contact between the input mechanism and the contact-sensitive screen at the start point and contact between the input mechanism and the contact-sensitive screen at a next point on the path of points; and
the gesture processor is further configured to identify remaining points of the path of points traversed by the gesture and the end point upon a determination that the time difference is less than a threshold amount of time.

17. The system of claim 16, wherein:
the gesture input detector is further configured to deactivate contact-sensing sensors of the contact-sensitive screen upon a determination that the time difference is greater than a threshold amount of time;
the gesture processor is further configured to:
determine a distance between the input mechanism and the contact-sensitive screen; and
reactivate the contact-sensing sensors of the contact-sensitive screen to identify the next point on the path of points upon a determination that the determined distance is within a threshold distance.

18. The system of claim 15, wherein a gesture rule of the plurality of gesture rules describes a threshold linearity of the gesture, the gesture processor further configured to:
measure, for each point on the path of points, a straightness of each segment of a gesture, wherein each segment of the gesture is formed between each point and a next point on the path of points;
aggregate the measured straightness for each segment of the gesture to determine a straightness measurement for the gesture; and
determine, upon the straightness measurement for the gesture being greater than the threshold linearity, a rule value for the gesture rule indicating that the gesture was performed intentionally.

19. The system of claim 15, wherein a gesture rule of the plurality of gesture rules describes a threshold angle between points on the path of points, the gesture processor further configured to:
measure, for each point on the path of points, an angle between the point and a next point on the path of points;
determine, upon the measured angle being less than the threshold angle, a rule value for the gesture rule indicating that the gesture was performed intentionally.

20. The system of claim 15, wherein a gesture rule of the plurality of gesture rules describes a threshold acceleration of intentionally performed gesture, the gesture processor further configured to:
determine a distance between a position of the start point on the contact-sensitive screen and a position of the end point on the contact-sensitive screen;
determine an acceleration of the gesture based on the determined distance and a velocity at which the gesture was performed; and
determine, upon a determination that the acceleration of the gesture is less than the threshold acceleration, a rule value for the gesture rule indicating that the gesture was performed intentionally.

21. The system of claim 15, wherein a gesture rule of the plurality of gestures rules describes a threshold size of points on the path of point, the gesture processor further configured to:
measure a size of each point on the path of points based on a count of contact-sensitive sensors activated by contact between the input mechanism and the contact-sensitive screen at the point; and
determine, upon the measured size being less than the threshold size, a rule value for the gesture rule indicating that the gesture was performed intentionally.
